(19) United States
(12) Patent Application Publication
(10) Pub. No.: US 2013/0185366 A1
(43) Pub. Date: Jul. 18, 2013

(54) SYSTEM AND METHOD FOR MANAGING USER GENERATED CONTENT

(71) Applicant: Joby Joy, Los Angeles, CA (US)

(72) Inventor: Joby Joy, Los Angeles, CA (US)

(21) Appl. No.: 13/724,733

(22) Filed: Dec. 21, 2012

Related U.S. Application Data
(60) Provisional application No. 61/583,454, filed on Jan. 5, 2012.

(51) Int. Cl. G06F 17/21

(52) U.S. Cl. CPC G06F 17/211; H04L 67/26; H04L 51/04
USPC 709/206; 715/202; 709/217

(57) ABSTRACT

A system and method for publishing and managing user generated content is provided. The system includes an authoring module, a subscription management module, and a publishing module. The authoring module may be configured to receive request from content publishers and generate online magazines in response to those requests. The interface for creating the magazine articles may provide real time previews of the input content across various reading platforms, providing the content creator with an efficient mechanism for ensuring that the magazine can be viewed across various platforms without errors and distortions.

### RELATED APPLICATIONS

This application claims the benefit of U.S. Provisional Patent Application No. 61/583,454, filed on Jan. 5, 2012, the entire disclosure of which is hereby incorporated by reference.

### BACKGROUND OF THE INVENTION

1. Field of the Invention

This application relates to user generated content.

2. Description of the Related Art

Prior to the advent of the Internet, publishing of widely distributed creative works was the province of selected few with access to the resources necessary to create the content, reduce the content to a tangible form (such as a glossy magazine), and then distribute the content to subscribers via relatively expensive distribution channels such as the postal service or the like. The Internet, and more specifically the World Wide Web, has removed many barriers to entry that had previously limited the ability of individuals to widely disseminate their creative works. No longer is it necessary to pay large printing costs and postage fees in order to reach a wide audience. Rather, using digital media, a single person armed with a computer, an Internet connection, and HTML skills can develop a web site which can be published on the World Wide Web and accessed by people around the world using conventional web browsing software.

Although there have been substantial improvements in the ability of individuals to self-publish and disseminate their creative works through the Internet, there remains a need for an online publishing platform which provides the ability of an individual user to easily create contents and distributed via a variety of distribution channels to a variety of different end user platforms.

### SUMMARY

In a first embodiment, a system for publishing and managing user generated content is provided. The system includes an authoring module having a magazine generation submodule, an edition submodule, an article submodule, and a page generation submodule. The authoring module is configured to receive a request to create a new magazine and execute the magazine generation submodule. The magazine generation submodule is configured to generate a new magazine comprising data indicative of the new magazine. The data may include a magazine title, a category, a short name, a category, and a description, and an accessibility level.

The authoring module is also configured to receive a request to create an edition of the new magazine and execute the edition submodule. The edition submodule is configured to generate an edition related to the new magazine. The edition may include an edition title, an edition date, and an accessibility level. The authoring module may further receive a request to create an article for the generated edition of the new magazine and then execute the article submodule. The article submodule is configured to generate an article related to the edition which includes a title, a description, and a comment status.

The authoring module may also receive a request to create a page for the generated article. In response, it may execute the page generation submodule which is configured to request a page template selection and receive a page template selection. Based on the page template selection, the page generation submodule may display a content input interface. The content input interface is configured to receive content specified by the page template selection and generate, in real time, and based on the content input a preview of the generated page. The preview may be indicative of how the page will be presented in a mobile device. The page generation submodule may further generate a page for the article display the generated page as a tile in a page selection interface. The magazine, the edition, the article, and the page may be stored in a memory.

In another embodiment, a method of publishing and managing user generated content is provided. The method includes receiving a request to create a new magazine. In response to the request, generating a new magazine comprising data indicative of the new magazine, the data indicative of the new magazine including a magazine title, a category, a short name, a category, and a description, and an accessibility level. The method further includes receiving a request to create an edition of the new magazine and generating an edition related to the new magazine, the edition including an edition title, an edition date, and an accessibility level. A request to create an article for the generated edition of the new magazine is also performed, and an article related to the edition is generated. The article includes a title, a description, and a comment status.

The method further includes receiving a request to create a page for the generated article, and in response to the request to create the page requesting a page template selection. A page template selection is then received. Based on the page template selection, a content input interface is displayed which is configured to receive content specified by the page template selection. The method also includes generating, in real time, and based on the content input, a preview of the generated page. The preview may be indicative of how the page will be presented in a mobile device. The method also includes generating a page for the article and displaying the generated page as a tile in a page selection interface. The magazine, the edition, the article, and the page are stored in a memory.

### BRIEF DESCRIPTION OF THE DRAWINGS

FIG. 1 is a high level overview of a system for managing user generated content in accordance with one or more embodiments.

FIG. 2 is a more detailed view of web server from FIG. 1.

FIG. 3 is a more detailed view of the application server from FIG. 2.

FIG. 4 is a more detailed view of the authoring module from FIG. 3.

FIG. 5 is a flowchart depicting a magazine creation process in accordance with one or more embodiments.

FIG. 6 is a flowchart depicting a process by which a page in a magazine article is created in accordance with one or more embodiments.

FIG. 7 is a flowchart depicting one example of a subscriber management process in accordance with one or more embodiments.

FIG. 8 is a flowchart depicting electronic magazine delivery process in accordance with one or more embodiment.

### DETAILED DESCRIPTION OF CERTAIN INVENTIVE EMBODIMENTS

Embodiments set forth herein provide non-technical users with the ability to self-publish and widely distribute their creative content, without the need for complex programming or paid distribution channels. Using various embodiments set forth herein, a user is able to build, update, maintain, and distribute a full-featured online magazine to a specific and defined target audience. The system provided an authoring module which is configured to provide a tiered page generation routine that allows a user to build a magazine from the ground up. The authoring module provides an interface for building the magazine structure, including the subparts such as editions, articles, and specific pages. One particularly useful feature is the ability of the user to receive a real-time preview of how a page will appear on specific mobile devices, so that the design and customization of that page may be more efficiently crafted to accommodate various platforms on which the page may be viewed. Certain embodiment also provide a simplified mechanism for wide-spread “push” distribution on a per article basis to a specified audience, while still allowing a general audience to easily access all aspects of a magazine, include each edition, and each article associated therewith.

The systems and methods described herein may be implemented in a general purpose computing environment. In one illustrative embodiment, various general purpose computing devices such as personal computers, mobile phones, touchpad computers, e-readers, and the like may be used to implement and run software configured to perform the methods described herein. Specialized computing devices such as computer network appliances may also be used in certain applications. Other types of computing devices may also provide platforms on which the system may be run. The system may be implemented in a networked computing environment. In some embodiments a wide area network such as the Internet may be utilized to communicate information between computing devices. The system may be implemented as a client/server application, web-based application accessible through browsing software, or it may be implemented utilizing some other computer medium.

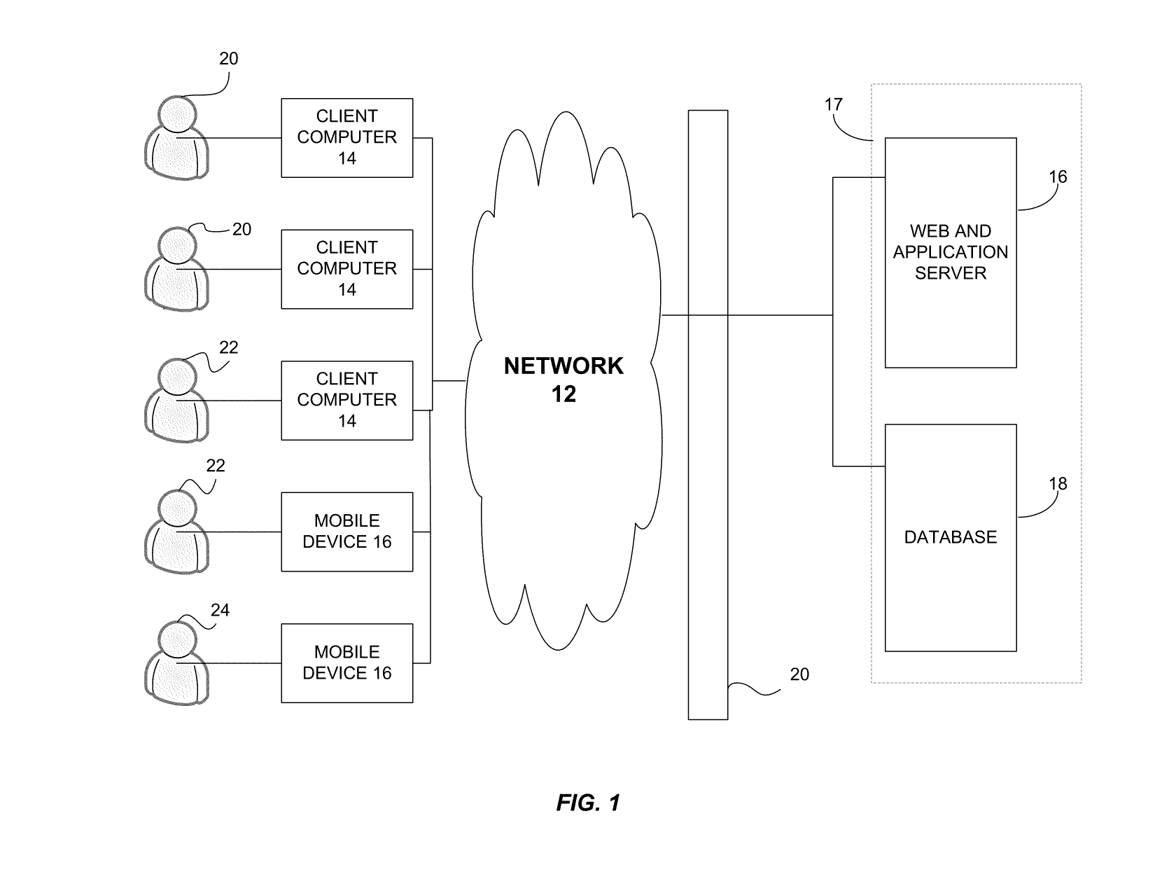

Referring now to FIG. 1, an example of one general purpose networked computing environment 10 which is suitable for practicing various embodiments is provided. The networked computing environment 10 may include a network 12. The network may be any type of computer network such as the Internet, a local area network, an Intranet, an extranet, or some combination of any of those types of networks. The network 12 may provide services to various entities which are involved in the online publishing environment disclosed herein. Connecting to the network 12 may an online publishing platform 17. The online publishing platform 17 may include one or more servers. These servers may include a web/application server 16, and a database server 18. In some embodiments, the web/application server 16 may be a web server configured to host various websites and various web applications. The web server may include an application service which allows it to connect to a database server 18 to add, retrieve, and update data to a database resident on the database server 18. In some embodiments, the database server 18 may be on the same hardware as the servers 16, or they may reside on a separate computing device. The web/application server 16 and database server 18 may be shielded from the network 12 by a firewall 20. The firewall 20 may be configured to protect the servers 16 and the database 18 from unauthorized network traffic and access attempts. In some embodiments, a portion, or all of the application/web server 16 may be placed “in front” of the firewall 20, while the database 18 may remain “behind” the firewall 20 to protect sensitive data. The firewall 20 may be configured to allow appropriate traffic in a manner well-known in the art.

Also connected to the network 12 may be one or more client computing devices 14 which access the network via a network interface device. The client computing devices 14 may take various forms including, but not limited to, general purpose computers running web browsing software, notebook computers, tablet computers, personal digital assistants, cellular telephones, other handheld devices, or some other computing device capable of accessing the network 12 through a defined application programming interface.

The client computing devices 14 may be operated by various users. The users may have various roles with respect to the online publishing system 17. For example, one or more client computing devices 14 may be operated by a publisher 20 who creates and/or manages content for the purpose of distribution via the publishing system 17. Also accessing the system 10 may be subscribers 22 who wish to utilize the publishing system to receive content from one or more publishers via the publishing system 17. The publishing system 17 may be further accessed by readers 24, who are not subscribers receiving push content, but instead users who access one or more magazines in the system 17 via a web browser. Although FIG. 1 describes a particular architecture and configuration for implementation, one of skill in the art will readily appreciate that the network environment 10 and the publishing system 17 described is but one of many possible configurations that may be utilized without departing from the scope of the invention.

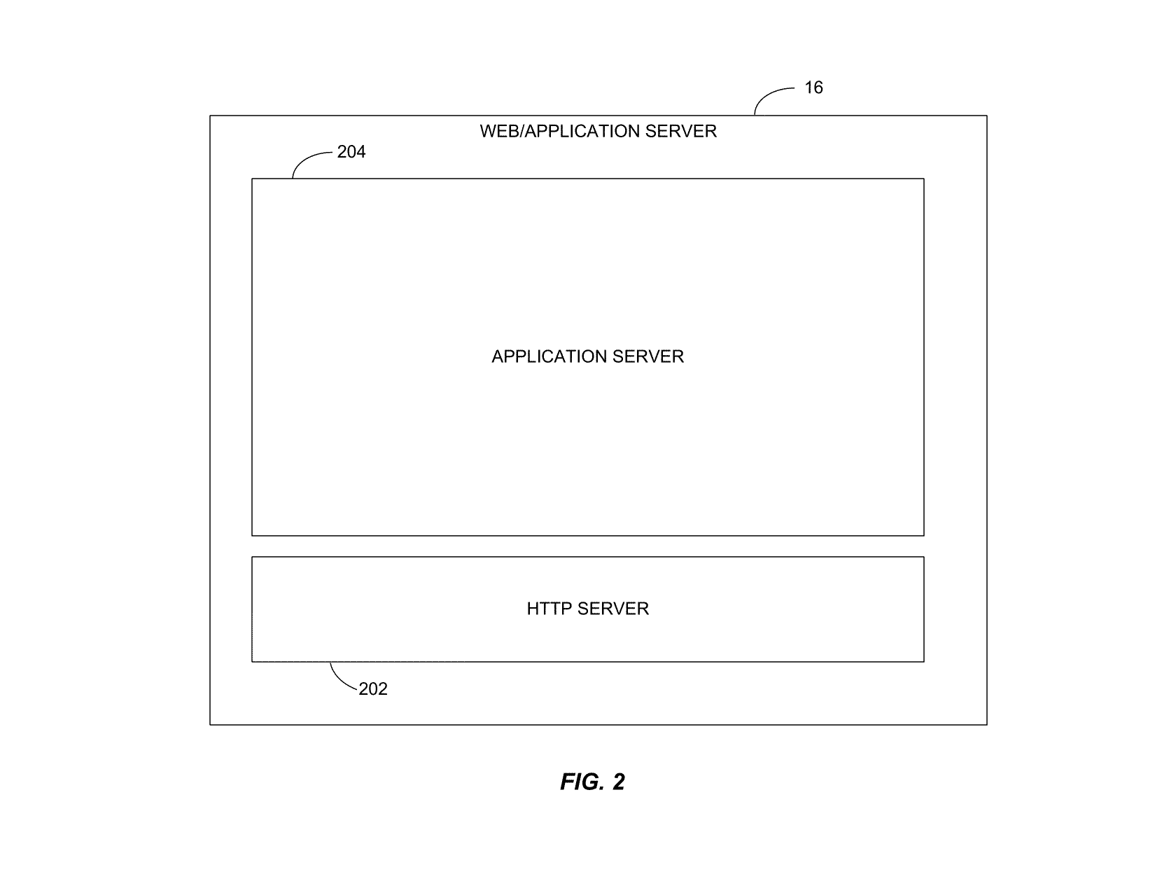

Turning to FIG. 2, a more detailed view of the web/application server 16 from FIG. 1 is provided. As shown, the web/application server 16 may include a hypertext transport protocol “HTTP” server 202 which is configured to serve web pages to client computers and mobile devices via the network 12. The HTTP server 202 may be a convention web server that is known in the art, such as an open source Apache web server running on a Linux platform, or it may also be a more proprietary software, such as the Internet Information Services (“IIS”) web server offered Microsoft. As will be discussed in more detail below, the HTTP server 202 may serve web pages which include magazine content for consumers, and it may also server web pages which include forms and other types of interfaces which may be used by publishers to create and manage content for their online magazines. The web/application server 16 may also include an application server 204. The application server 204 is generally designed to serve as an interface between the web server 202 and the database server 18. The application server 204 may take various forms. In one embodiment, the application server 204 may provide scripting services which enable the http server 202 to make requests from the database 18. The application server 204 may provide this interface through a scripting language such as PHP, CGI, PERL or the like. Alternatively, the application server 204 may also take the form of a more robust middleware application such as .NET, ColdFusion, or some other type of middleware. As can be readily appreciated by a skilled artisan, these are but a few examples of the various configurations that may be utilized to provide the publishing system 17.

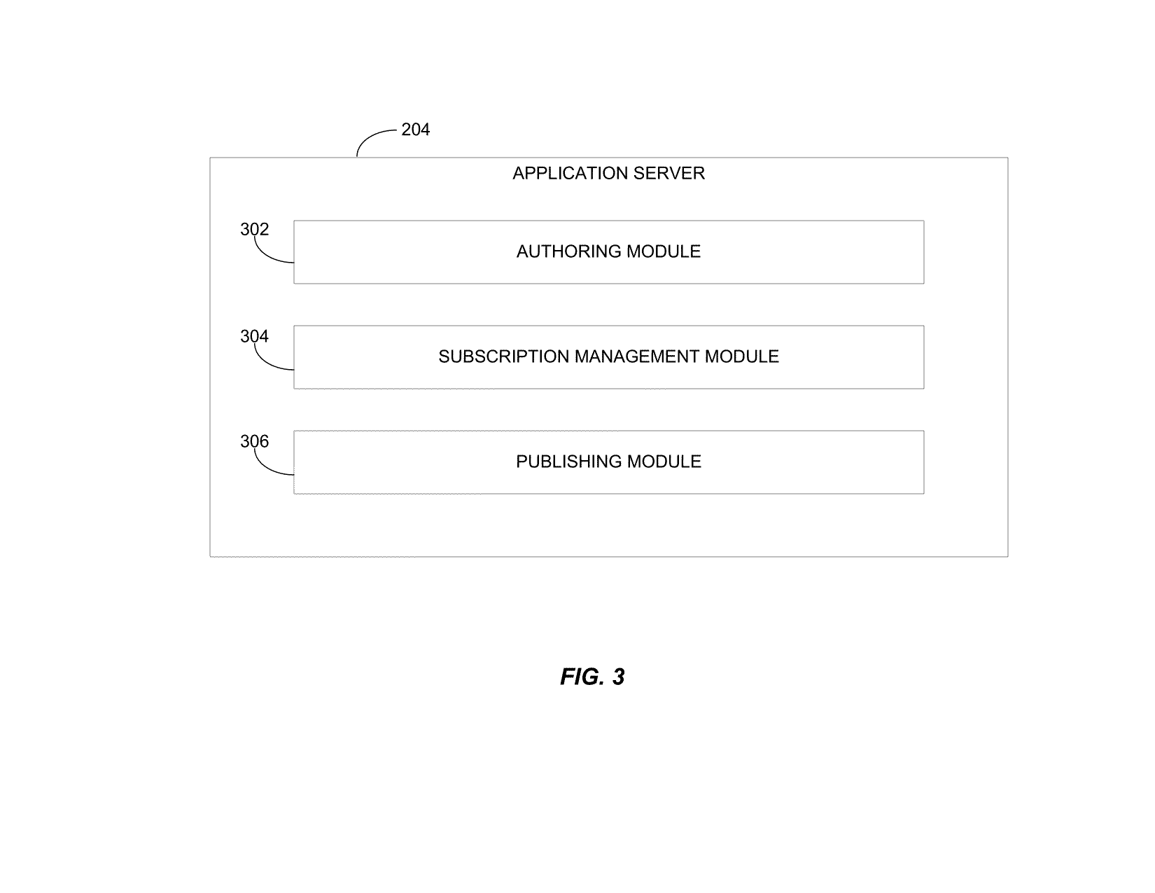

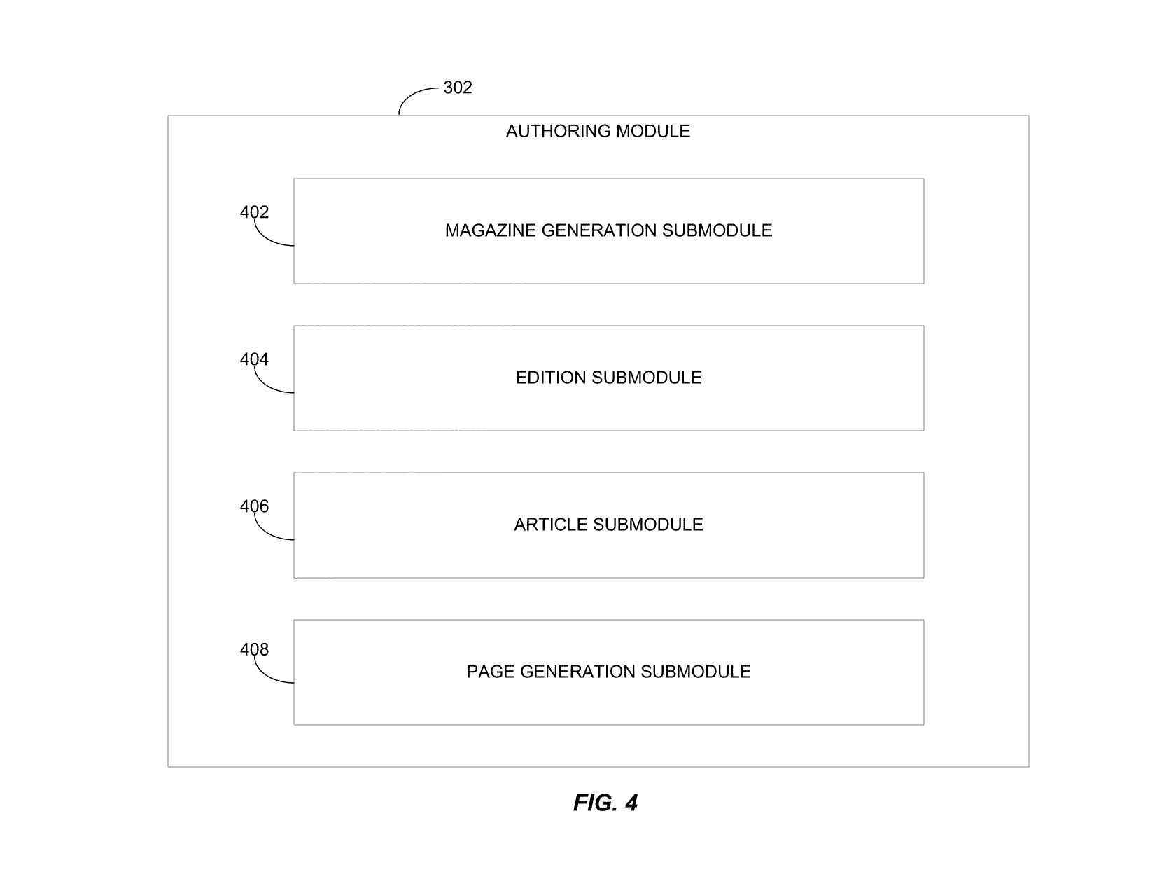

Turning to FIG. 3, a more detailed view of the application server 204 from FIG. 2. As shown, the application server 204 may include various modules which provide publishing capabilities and services within the publishing system 17. These modules may include an authoring module 302. The authoring module 302 may be configured to allow a publisher user to access the system 17 and create and save creative works for distribution to other users and subscribers. The authoring module 302 will be discussed in addition detail in connection with FIG. 4 below.

The application server 302 may also include a subscription management module 304. The subscription management module 304 may be configured to allow a publisher 20 to use the publishing system 17 to create, authorize, manage, and allocate rights to subscribers 22 so that they may access content produced using the authoring module 302. In order to manage subscriptions to the various magazines in the publishing system 17, the subscription management module 304 may be configured to maintain lists of subscribers in tables in the database 18. The lists may include a plurality of related database table which, through the use of primary and foreign keys, allow for the efficient storage and management of subscriptions within the publishing system 17.

In one exemplary subscription management module 304, the subscription management module may be configured to allow the publisher 20 to define a specific access level for each online magazine developed and published by the publisher 20. These access levels may include a subscriber only level which allows only a subscriber 22 who has been provided access to the magazine to have access to its content. The publisher 20 may also designate a magazine has having “open” access, such that all subscribers 22 and also those non-subscribers accessing the publishing system 17 may have access to the content in the magazine.

In some embodiments, the subscription management module 304 may be configured allow the publisher 20 to define access right more granularly than on a per magazine basis. For example, a publisher may provide open access to one edition of a magazine, while restricting access to subscribers for other editions. In addition, the subscription management module 304 may further allow a publisher 20 to define access on a per article basis as well. This capability may be useful for allowing “teaser” content to be freely distributed to entice additional magazine subscriptions, while subscriber-only content remains protected from general viewing by all users. In still other embodiments, the subscription management module 304 may be configured to allow the publisher 20 to even define user access on a per page basis, thereby providing yet another potential avenue for providing “teaser” content to the general consuming public.

The subscription management module 304 may also allow a publisher to receive subscription requests to one or more generated magazines from subscribers 22. In response to those requests, the publisher 20 may either add the subscribers 22 to the database as having rights to the requested magazine. In some embodiments, the subscriber 22 may be automatically added upon request. In other embodiments, the subscription management module may be configured to determine the accessibility level of the magazine(s) requested by the subscriber in order to determine whether to grant the subscription request.

In some additional embodiments, the subscription management module may be configured to allow a publisher 20 to transfer ownership of a magazine to another publisher, while maintaining control of their account within the system. A publisher 20 may maintain a magazine as part of their duties in an organization. For example, a publisher 20 may be a member of a college fraternity and be responsible for maintain a magazine dedicated to the fraternity. Upon graduation from college, the magazine will continue, but the publisher will no longer seek to maintain the magazine. Accordingly, the subscription management module may be configured to permit the publisher 20 to transfer the magazine to another user, thereby “passing the torch” to the next publisher 20. However, in doing so, the publisher need not relinquish control of their account, which may have one or more additional magazines associated with it. Instead, the control over only the single magazine is transferred to another user.

The application server 204 shown in FIG. 3 also may include a publishing module 306. The publishing module 306 may be configured to access user generated content that has been stored in the database 18, to format it for presentation in various different types of devices that may be used to read the magazine, and to deliver the content as appropriate to users and subscribers. The publishing module may be configured to deliver content in various ways. In some embodiments, the publishing module 306 may access the magazine data from the database 18 and format it for presentation within a standard web browser such as Internet Explorer, Firefox, Safari, or Chrome. The publishing module 306 may also be configured to take the magazine content data and structure it for effective presentation within a reading application such as those found on a Kindle, a Nook, or some other e-reading system. The publishing module 306 may also provide a search capability, which allows users accessing the publishing system 17 to search for magazines that may be of interest using keywords or some other search criterion.

In some embodiments, the publishing system 17 may provide a specific reading application that may be installed on various types of devices to allow for even more functionality with respect to delivering content. For example, a mobile device application may be provided that is available from an application store associated with a specific mobile platform, such as AppStore for the iPhone, or the Android Market for Android. These applications may provide additional functionality such as allowing content to be stored on the local device, or providing subscribers with more robust interfaces for managing their content and subscriptions.

Turning now to FIG. 4, a more detailed view of the authoring module 302 is provided. As shown, the authoring module 302 may include a magazine generation submodule 402, an edition submodule 404, an article submodule 406, and a page generation submodule 408. Each of these submodules may provide a specific functionality within the framework provided by the authoring module 302 for creating content to be delivered by the publishing module 306.

The magazine generation submodule 402 is used by the publisher 20 to create a new magazine title for distribution from the publishing system 17. The magazine is the highest level construct for the content that may be inputted into the system by the publisher 20. In creating the magazine, the publisher 20 may submit various types of information to the publishing system 17. This information may include a magazine title which provides the title for the magazine. The information may further include a category for the magazine. The category for the magazine may be used by the publishing module 306 to provide search capability as described above. The publisher 20 may also provide a short name for the magazine, which may be a more informal term or phrase that may be used to describe the publication. For example, “Gentleman's Quarterly” may have a short title of “GQ.” The magazine creation process may also ask the publisher to input a description for the magazine. This description may also be used to in the context of keyword searching for magazine titles, as well as provide better information to users as they browse the magazine catalog and determine their interest in any particular title.

Referring back to FIG. 4, the authoring module 302 may also include an edition submodule 404. Each magazine created using the magazine generation submodule 402 may include one or more editions. The edition submodule 404 is generally used to create an edition for a generated magazine. The edition submodule 404 may collect data related to an edition of the magazine. The edition may be a periodical edition, such as a monthly, bi-weekly or even daily edition. Alternatively, the editions may be created and/or published as irregular intervals. The edition submodule 402 may request information from the publisher 20, including an edition title, an edition date, and an accessibility level for the edition. As noted above, the defining an accessibility level for the edition allows the publisher 20 to selectively determine which content to make generally available, and which content to limit to subscribers.

Each edition created by the publisher 20 may include one or more articles which are delivered using the publishing module 306. The articles may be created using the article submodule 406 of the authoring module 302. The article submodule may be invoked to create an article for an edition of the magazine. The article may include information such as an article title, a description for the article, an author for the article, an accessibility level for the article, and the comment status. The comment status may determine whether readers of the article are permitted to leave comments regarding the article.

The creation of an article provides the user with the ability to assemble and associate pages having creative content with the article. These pages may be created using the page generation submodule 408. The page generation submodule 408 provides an interface which allows a publisher 20 to create and design the look and feel of the pages that are included in an article. The page generation submodule 408 may provide a series of page templates from which the publisher 20 may select a design, look, and structure for each page created. The selected template may be incorporated into the content input interface, which may include one or more text input fields and other input elements which can be used to populate the content of the page. Different page templates may be provided based on the specific role in the article that the page is playing. For example, a title page template may be provided which provides an interface for creating a title page for an article. A multimedia template may provide an interface for allowing multimedia content to be uploaded and displayed within the pages of the article. The multimedia content may include images, video, audio, or some combination thereof. Other types of templates may include text only page templates, advertising templates which are designed to allow web advertisements to be delivered from a third party web advertising service. In some embodiments, the article pages may be required by the publishing system 17 to provide page real estate so that the publishing system 17 may function as an ad-supported system.

Because the articles may be delivered via various consumption platforms, it may be very useful for the publisher to easy determine how a particular page may look in a particular platform. In order to provide this capability, some embodiments of the page generation submodule may include a preview capability. The preview capability may be provided for specific selectable platforms, and may be delivered in real time as content as added to the page using the input form. In some embodiments, the preview capability may be directed to a specific mobile device, such as an iPhone. In other embodiments, multiple device platform previews may be simultaneously generated so that the publisher can see in real time how the article page will be generated across the various platforms likely to view the content. These preview windows may be generated using, for example, Java applets which are loaded with the input page, and which read the content as it is input into the forms of the page generation module. Thus, as a page is created, the user may see a preview for an iPhone, an Android phone, a tablet computer, a Kindle, and some other platform in real time.

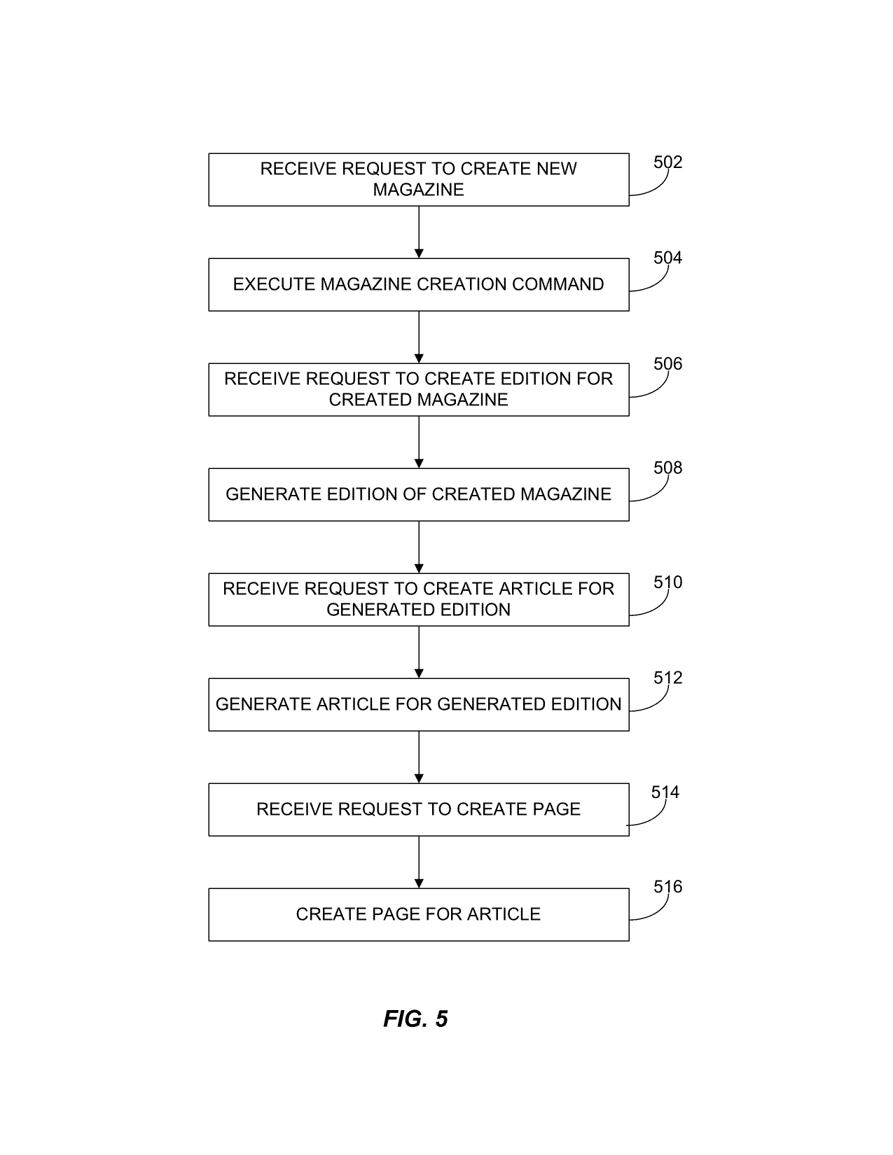

Using the modules, submodules, and other components described above, a publisher 20 is able to create, manage, and distribute creative content via the publishing system 17. FIGS. 5-8 provide examples of various processes that may be performed in the context of the online publishing aspects of the publishing system 17.

Starting with FIG. 5, a flowchart depicting a magazine creation process is provided. The process begins at block 502, where a request to create a new magazine is received by the publishing system 17 via the magazine generation submodule 402. The process them moves to block 504 where the magazine generation submodule executes a magazine creation command in the application server 202. This request creates a new entry in the database 18 associated with the publisher 20 and magazine as well. The process then moves to block 506, where a request is received from the publisher 20 to create an edition for the magazine generated by the magazine generation module 402. The request may be received by the edition module 404. In response to the request, the edition module 404 may generate an edition of the magazine, and store the edition in the database 18. Once the edition has been created, the publisher 20 may then begin creating article for the generated edition. Thus, the process may then move to block 508, where the edition of the magazine is generated by the system.

Once the edition has been created and stored in the database 18, the process then moves to block 510, where the magazine generation submodule 408 may receive a request from the publisher 20 to create an article for the edition. The article submodule 406 may then be invoked as described above, and a new article may generated and written in the database 18 in block 512. Once the article has been created, the process may then move to block 514, where the publisher 20 access the page generation submodule 408 to request that a page be created for the article. As noted above, the request may include template selection and the input of content into the selected template. The request is received by the page generation submodule 408. In response to the request, the page generation submodule 408 may generate the requested page, as shown in block 516.

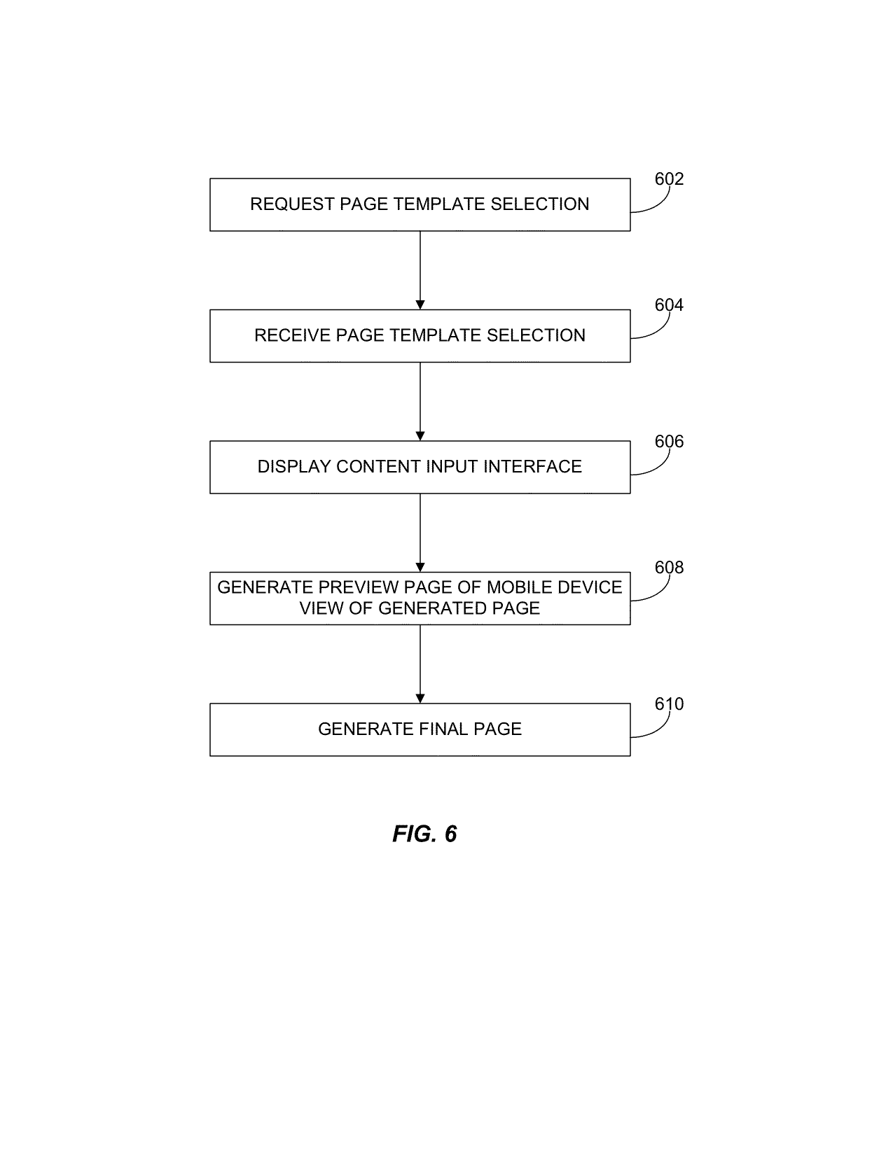

Turning now to FIG. 6, a more detailed view of the process by which a magazine page is created is provided. The process beings at block 602, where the publisher 20 requests a page template to use for the article page. Once the request is made, the page generation submodule 408 receives the request, and the process then moves to block 604. The process then moves to block 606, where the content input interface selected and displayed in accordance with the page template selection made by the publisher 20. The publisher 20 may input data into the content input interface. The data may include article copy, picture content, video content or the like. As the content is input, the process then moves to block 608, where the page generation submodule 408 generates a real time preview of the page. As noted previously, the preview may be provided for a single mobile platform, or it may be provided for several platforms simultaneously. Once the preview has been generated, and the publisher is satisfied with how it renders on each platform, the page may then be generated and stored in the database 18 at block 610.

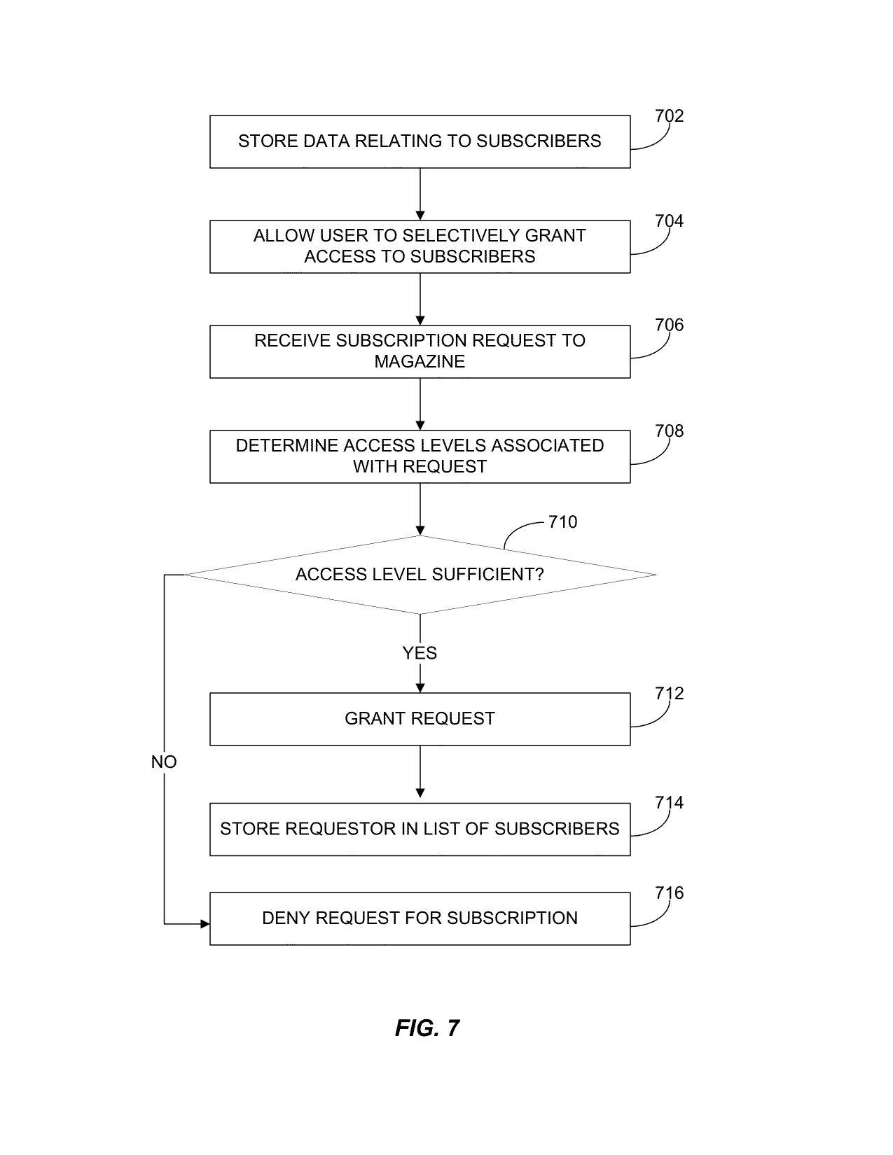

As discussed above in connection with FIG. 3, subscription management module 304 may be configured to allow a publisher 20 to use the publishing system 17 to create, authorize, manage, and allocate rights to subscribers 22 so that they may access content produced using the authoring module 302. FIG. 7 is a flowchart showing a subscriber management process which may be performed by the subscriber management module 304 in accordance with one or more embodiments of the invention.

The process begins at block 702, where the publishing system 17 stores data relating to magazine subscribers 22. The process then moves to block 704, where the publisher 20 is given the ability to selectively grant access to the subscribers 22 stored in the database 18. As noted above, the selective access can be extremely granular and customized to the particular publishing needs of the publisher 20. Next, the process moves to block 706, where a subscription request is received for a magazine in the database. The request may be made by an end user accessing the publishing system 17 using a web interface, for example. Next the process moves to block 708, where the publishing system determines the access levels associated with the request. For example, the publishing system may look at an access level defined for the magazine itself, as described above in connection with FIG. 3. In addition, access permissions associated with user making the request may also be considered. For example, a particular user may have increase access rights by virtue of being a paid subscriber or an advertiser within the publishing system 17.

Once the access levels associated with the request have been identified, the process then moves to decision block 710. If the user making the request has sufficient access rights, the process moves to block 712, where the request is granted and the subscription to the magazine is provided. Once the subscription request has been granted, the requestor is then stored in the list of subscribers associated with the magazine, so that the subscriber may be recognized and permitted access to the content going forward. If at decision block 710, it is determined that the access rights associated with the request are insufficient, the process then moves to block 716, where the request is denied.

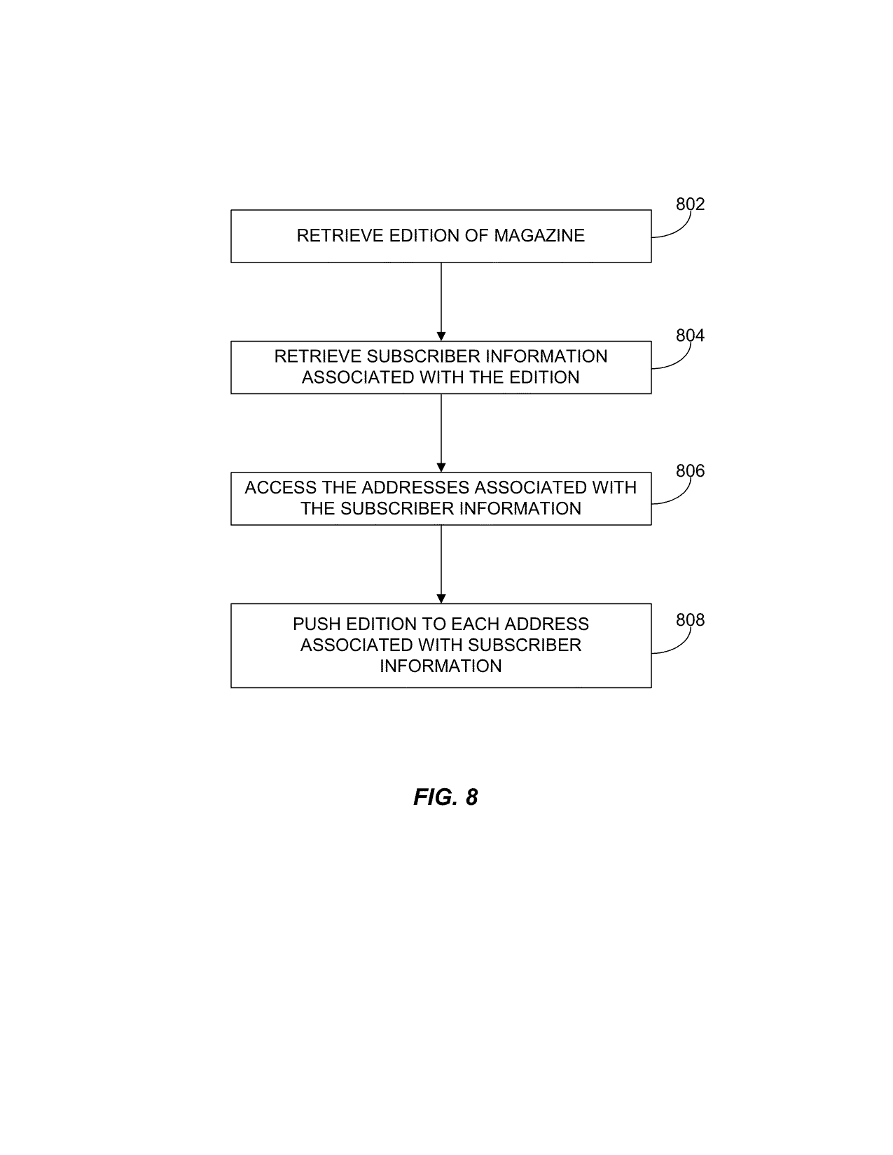

As discussed above, the publishing module 306 may be configured to push magazine content to the various platforms associated with subscribers 22. FIG. 8 is a flowchart depicting one example of an electronic magazine delivery process in accordance with one or more embodiments. The process begins at block 802, where the publishing module 306 retrieves the edition of the magazine that is to be delivered. Next, the process moves to block 804, where the subscriber information associated with the edition of the magazine is retrieved from the database 18. Next, the process moves to block 806, where the addresses associated with the list of subscribers are retrieved from the database. Once the addresses have been retrieved, the publishing module 306 then pushes the magazine edition to the subscribers as their associated addresses at block 808.

Utilizing the embodiments described above, a flexible and efficient online magazine creation and distribution system can be provided which allows content creators to provide wide spread distribution of their creative works without the need for technical skills or substantial investments in delivery resources. Those of skill will recognize that the various illustrative logical blocks, modules, circuits, and algorithm steps described in connection with the embodiments disclosed herein may be implemented as electronic hardware such as a general purpose or special purpose computer having one or more computer processors, computer software, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A system for publishing and managing user generated content, comprising:
an authoring module having a magazine generation submodule, an edition submodule, an article submodule, and a page generation submodule, the authoring module configured to:
receive a request to create a new magazine;
execute the magazine generation submodule, wherein the magazine generation submodule is configured to generate a new magazine comprising data indicative of the new magazine, the data indicative of the new magazine including a magazine title, a category, a short name, a description, and an accessibility level;
receive a request to create an edition of the new magazine;
execute the edition submodule, wherein the edition submodule is configured to generate an edition related to the new magazine, the edition including an edition title, an edition date, and an accessibility level;
receive a request to create an article for the generated edition of the new magazine;
execute the article submodule, wherein the article submodule is configured to generate an article related to the edition, the article including a title, a description, and a comment status;
receive a request to create a page for the generated article;
execute a page generation submodule, wherein the page generation submodule is configured to
request a page template selection;
receive a page template selection;
based on the page template selection, display a content input interface, wherein the content input interface is configured to receive content specified by the page template selection;
generate, in real time, and based on the content input a preview of the generated page, the preview indicative of how the page will be presented in a mobile device; and
generate a page for the article; and
display the generated page as a tile in a page selection interface,
wherein the authoring module is further configured to store the magazine, the edition, the article, and the page in a memory.

2. The system of claim 1, further comprising a subscription management module configured to:
store data relating to subscribers;
allow users to selectively grant access to the magazine to one or more of the subscribers.

3. The system of claim 2, wherein the subscription management module is further configured to:
receive subscription requests to one or more generated magazines;
in response to the subscription request, determine the accessibility level of the each of the one or more requested magazines; and
grant the subscription request based on the determined accessibility level; and
store a list of subscribers to each of the one or more requested magazines.

4. The system of claim 3, wherein the received subscription requests comprise data indicative of one or more addresses associated with the subscriber.

5. The system of claim 4, wherein the one or more addresses associated with the subscriber comprise one or more of a phone number, an e-mail address, a microblogging service, and a social media account address.

6. The system of claim 5, further comprising a publishing module configured to:
retrieve the edition generated by the authoring module;
retrieve a list of subscribers associated with the edition;
access the addresses associated with the retrieved subscribers; and
push the retrieved edition of the magazine to the addresses associated with the retrieved subscribers.

7. The system of claim 6, wherein the retrieved edition of the magazine includes a plurality of articles.

8. The system of claim 7, wherein a link to the plurality of articles is pushed to the addresses associated with the retrieved subscribers via a broadcast text message to mobile phones associated with the subscribers.

9. The system of claim 7, wherein a link to the plurality of articles is pushed to the address associated with the retrieved subscribers via a broadcast e-mail message to e-mail addresses associated with the subscribers.

10. The system of claim 7, wherein the content of the plurality of articles to pushed to the addresses associated with the retrieved subscribers via an application running on the mobile devices associated with the subscribers.

11. A method of publishing and managing user generated content, the method comprising:
receiving a request to create a new magazine;
generating, in response to the request, a new magazine comprising data indicative of the new magazine, the data indicative of the new magazine including a magazine title, a category, a short name, a category, and a description, and an accessibility level;
receiving a request to create an edition of the new magazine;
generating an edition related to the new magazine, the edition including an edition title, an edition date, and an accessibility level;
receiving a request to create an article for the generated edition of the new magazine;
generating an article related to the edition, the article including a title, a description, and a comment status;
receiving a request to create a page for the generated article;
in response to the request to create the page:
requesting a page template selection;
receiving a page template selection;
displaying, based on the page template selection, a content input interface, wherein the content input interface is configured to receive content specified by the page template selection;
generating, in real time, and based on the content input, a preview of the generated page, the preview indicative of how the page will be presented in a mobile device; and
generating a page for the article; and
displaying the generated page as a tile in a page selection interface,
wherein the magazine, the edition, the article, and the page are stored in a memory.

12. The system of claim 1, further comprising a subscription management module configured to:
store data relating to subscribers;
allow users to selectively grant access to the magazine to one or more of the subscribers.

13. The system of claim 2, wherein the subscription management module is further configured to:
receive subscription requests to one or more generated magazines;
in response to the subscription request, determine the accessibility level of the each of the one or more requested magazines; and
grant the subscription request based on the determined accessibility level; and
store a list of subscribers to each of the one or more requested magazines.

14. The system of claim 3, wherein the received subscription requests comprise data indicative of one or more addresses associated with the subscriber.

15. The system of claim 4, wherein the one or more addresses associated with the subscriber comprise one or more of a phone number, an e-mail address, a microblogging service, and a social media account address.

16. The system of claim 5, further comprising a publishing module configured to:
retrieve the edition generated by the authoring module;
retrieve a list of subscribers associated with the edition;
access the addresses associated with the retrieved subscribers; and
push the retrieved edition of the magazine to the addresses associated with the retrieved subscribers.

17. The system of claim 6, wherein the retrieved edition of the magazine includes a plurality of articles.

18. The system of claim 7, wherein a link to the plurality of articles is pushed to the addresses associated with the retrieved subscribers via a broadcast text message to mobile phones associated with the subscribers.

19. The system of claim 7, wherein a link to the plurality of articles is pushed to the address associated with the retrieved subscribers via a broadcast e-mail message to e-mail addresses associated with the subscribers.

20. The system of claim 7, wherein the content of the plurality of articles to pushed to the addresses associated with the retrieved subscribers via an application running on the mobile devices associated with the subscribers.
